(19) United States
(12) Patent Application Publication
(10) Pub. No.: US 2020/0041429 A1
(43) Pub. Date: Feb. 6, 2020

(54) NONDESTRUCTIVE INSPECTION APPARATUS AND METHOD FOR MICRO DEFECT INSPECTION OF SEMICONDUCTOR PACKAGING USING A PLURALITY OF MINIATURE X-RAY TUBES

(71) Applicant: Korea Advanced Institute of Science and Technology, Daejeon (KR)

(72) Inventors: Sung Oh Cho, Daejeon (KR); Hyun Nam Kim, Daejeon (KR)

(21) Appl. No.: 16/528,873

(22) Filed: Aug. 1, 2019

(30) Foreign Application Priority Data
Aug. 3, 2018 (KR) 10-2018-0090773

(51) Int. Cl. G01N 23/2251; G01T 1/20; G01N 23/083

(52) U.S. Cl. CPC G01N 23/2251; G01N 2223/1016; G01N 23/083; G01T 1/20

(57) ABSTRACT

The present invention relates to a nondestructive inspection apparatus and method for micro defect inspection, and more particularly, to a nondestructive inspection apparatus and method, which is capable of magnifying and observing a nondestructive inspection result while maintaining a resolution of the same when micro defect inspection is performed through a nondestructive inspection using beams. The nondestructive inspection apparatus for micro defect inspection includes a light source unit configured to project a beam to an object, a light detection unit having at least one surface contacting the object to generate light by detecting the beam that is transmitted through the object and arrived, an optical unit configured to form an image by using the light generated from the light detection unit, and a defect detector configured to determine whether a defect is generated by using the image.

### CROSS-REFERENCE TO RELATED APPLICATIONS

This U.S. non-provisional patent application claims priority under 35 U.S.C. § 119 of Korean Patent Application No. 10-2018-0090773, filed on Aug. 3, 2018, the entire contents of which are hereby incorporated by reference.

### BACKGROUND

The present disclosure herein relates to a nondestructive inspection apparatus and method for micro defect inspection, and more particularly, to a nondestructive inspection apparatus and method, which is capable of magnifying and observing a nondestructive inspection result while maintaining a resolution of the same when micro defect inspection is performed through a nondestructive inspection using beams.

Electronic devices such as mobile phones, computers, and tablet PCs have been dramatically improved in performance, and, demands for a semiconductor integrated circuit, which include miniaturization and low power consumption, have been gradually increased due to the Fourth Industrial Revolution such as Internet of Things (IoT), cloud services, and autonomous vehicles.

During the past 40 years, the performance of the semiconductor integrated circuit doubles about every two years under Moor's law. However, due to the limitation of the lithography technology, a pattern size of the semiconductor circuit is hardly reduced into 10 mm or less. Also, as the pattern size is reduced, a quantum phenomenon occurs, and thereby the degree of semiconductor integration hardly increases.

As a measure for increasing the degree of semiconductor integration, three dimensional lamination packaging technology for vertically laminating semiconductor chips has been developed. In order to performing the three-dimensional IC packaging, layers of IC chips are necessarily connected to each other. As shown in the left side of FIG. 1, a wire bonding method, which connects chips by using a thin wire, is initially used. However, as the size of the chip gradually decreases, the above-described bonding technology causes limitations such as signal propagation delay, increase in power consumption, and limitation in high performance.

As an alternative of the wire bonding technology, the semiconductor lamination packaging technology with a through silicon via (TSV) applied has been developed. Here, TSV represents a technology of forming a via hole, which has a size of several mm to several tens mm and vertically passes through various laminated chips, and then filling a conductive material such as copper into the via hole to transmit an electrical signal between chips. In comparison with the conventional wire bonding method, since a connection length between chips remarkably decreases, and a greater number of chips are connectable, the high integration, low power consumption, high speed, and miniaturization of the semiconductor may be realized.

In general, since the TSVs are closely disposed while being spaced several mm from each other, several hundred thousands or more TSVs may be defined in one wafer. Since the TSV has a size of several μm to several tens μm, and uniform filling of the conductive material into extremely many TSVs is not simple, many defects are generated in TSVs. For example, defects such as a defect in which the conductive material is not completely filled into the via hole, a defect in which a void is generated inside the conductive material, a defect in which solder bumps contact each other, and a defect of misalignment between the TSV and the solder bump are generated. Since the above-described defects affect the whole operation of the chip, the production yield and the operational reliability are degraded.

Although an electron microscope having a resolution of several nm may exactly observe a defect generated in a surface, since a wafer is required to be cut and a cross-section of the wafer is measured, the product is inevitably damaged. Thus, this method may not be applied to a production line, and may be used only when a specific portion is precisely measured in research and development processes. Also, the expensive focused ion beam (FIB) is required to be used for cutting a wafer. Here, since a defected portion is not recognized, each of the TSVs is required to be cut and observed, and thus much time is consumed.

Therefore, a method of observing with a high resolution to find defects without damaging a product through a nondestructive inspection is required.

### SUMMARY

The present disclosure provides a nondestructive inspection apparatus and method for micro defect inspection, which is capable of inspecting whether a defect is present in a wide range at one time while maintaining a resolution of an inspection image.

Embodiments of the present invention are directed to provide a nondestructive inspection apparatus for micro defect inspection, the nondestructive inspection apparatus including: a light source unit configured to project a beam to an object; a light detection unit having at least one surface contacting the object to generate light by detecting the beam that is transmitted through the object and arrived; an optical unit configured to form an image by using the light generated from the light detection unit; and a defect detector configured to determine whether a defect is generated by using the image.

According to an embodiment of the present invention, the light source unit may be provided in plurality, and each of the plurality of light source units may project a beam to a different area.

According to an embodiment of the present invention, the light source unit may generate an X-ray.

According to an embodiment of the present invention, the light source unit may include a micro-focus X-ray tube or a miniature X-ray tube.

According to an embodiment of the present invention, the optical unit may be provided in plurality, and the plurality of optical units may be contained in an area at which a beam projected from each of the plurality of light source units is arrived.

According to an embodiment of the present invention, the optical unit may magnify or reduce an image formed by the light generated from the light detection unit.

According to an embodiment of the present invention, the defect detector may be provided in plurality, and the plurality of defect detectors may be disposed at positions corresponding to the plurality of optical units.

Embodiments of the present invention are also directed to provide a nondestructive inspection method for micro defect inspection, the nondestructive inspection method including: projecting a beam to an object; generating light by detecting the beam that is transmitted through the object and arrived; forming an image by using the generated light; and determining whether a defect is generated by using the image.

According to an embodiment of the present invention, the projecting of the beam may project the beam to a plurality of different areas.

According to an embodiment of the present invention, the beam projected in the projecting of the beam may be an X-ray.

According to an embodiment of the present invention, the projecting of the beam may project the X-ray by using a micro-focus X-ray tube or a miniature X-ray tube.

According to an embodiment of the present invention, the forming of the image may form a plurality of images by using light generated from the plurality of areas at which the beam is arrived.

According to an embodiment of the present invention, the forming of the image may magnify or reduce the image.

According to the present invention, a non-destructive inspection can be performed while enlarging an image of a non-destructive inspection while maintaining resolution.

In addition, it is possible to inspect defects in a wider range of objects than the existing non-destructive inspection method, thereby providing a technique for shortening the inspection time.

The effects of the present invention are not limited to the above-mentioned effects, and various effects can be included within the scope of what is well known to a person skilled in the art from the following description.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a view illustrating a nondestructive inspection apparatus for micro defect inspection according to an embodiment of the present invention:

FIG. 2 is a view illustrating a nondestructive inspection apparatus for micro defect inspection according to an embodiment of the present invention;

FIG. 3 is a view illustrating an ultra-miniature X-ray tube according to an embodiment of the present invention;

FIG. 4 is a view illustrating blurring generated in a nondestructive inspection according to an embodiment of the present invention;

FIGS. 5 to 7 are views for explaining an effect of the nondestructive inspection according to an embodiment of the present invention;

FIG. 8 is a flowchart representing a nondestructive inspection method for micro defect inspection according to an embodiment of the present invention; and

FIG. 9A is a view showing an X-ray image obtained by the micro defect inspection according to a conventional method, and FIG. 9B is a view showing an X-ray image obtained by a micro defect inspection according to an embodiment of the present invention.

### DETAILED DESCRIPTION

Hereinafter, a “nondestructive inspection apparatus and method for micro defect inspection” according to the present invention will be described in detail with reference to the accompanying drawings. Described embodiments below are provided to allow those skilled in the art to understand the scope of the preset invention, but the present invention is not limited thereto. Furthermore, shapes of the elements illustrated in the figures may be provide for explaining embodiments of the invention and thus be different from substantially realized shapes.

Also, each configuration described herein is provided as an example for embodying the present invention. Thus, in another embodiment of the present invention, another configuration may be used without departing from the spirit or scope of the invention

Also, each configuration may be realized by only hardwares or softwares, or a combination of various hardwares and softwares performing the same function. Also, two or more configurations may be realized by one hardware or software.

The meaning of “include,” “comprise,” “including,” or “comprising,” specifies a property, a region, a fixed number, a step, a process, an element and/or a component but does not exclude other properties, regions, fixed numbers, steps, processes, elements and/or components.

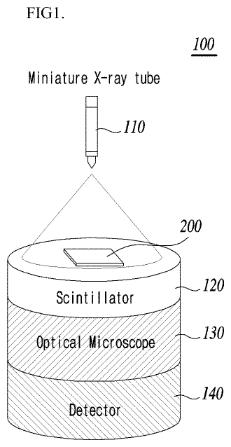

FIG. 1 is a view illustrating a nondestructive inspection apparatus for micro defect inspection according to an embodiment of the present invention.

Referring to FIG. 1, a nondestructive inspection apparatus 100 for micro defect inspection according to an embodiment of the present invention may include a light source unit 110, a light detection unit 120, an optical unit 130, a defect detector 140, and an object 20X).

The light source unit 110 may generate a beam. The beam generated from the light source unit 110 may be shot or emitted toward the object 200. The beam generated from the light source unit 110 may be emitted only in a specific direction or to a specific area. The beam generated from the light source unit 110 may include an X-ray, a laser, and a gamma-ray. Preferably, the beam may be the X-ray. The light source unit 110 may include a micro-focus X-ray tube or a miniature X-ray tube, and, a preferred embodiment may include the miniature X-ray tube. The light source unit 110 may generate the X-ray by using a carbon nanotube. The light source unit 110 may emit the beam to a whole or a portion of the object 200. The light source unit 110 may move or change an area to which the beam is projected. The light source unit 110 may move or change the area to which the beam is projected in order to project the entire object 200. The light source unit 110 may adjust a distance to the object. The light source unit 110 may adjust a size of the area to which the beam is emitted to the object 200. The light source unit 110 may allow the beam to be emitted to the object 200 and then arrived at the light detection unit 120. Although the light source unit 110 may emit the beam in a shape such as a circle, a rectangle, a triangle, or a hexagon, the embodiment of the present invention is not limited thereto. For example, the light source unit 110 may emit the beam in various shapes.

The light detection unit 120 may detect the beam when the beam emitted from the light source unit 110 arrives thereto. The light detection unit 120 may diffuse, form, or generate light when the beam is detected. The light detection unit 120 may have at least one surface contacting the object 200. The light detection unit 120 may receive the beam emitted from the light source unit 110 through the surface contacting the object 200. The light detection unit 120 may include a scintillator. The scintillator may contain a fluorescent material that emits light when collides with radioactive rays. The scintillator may include an inorganic scintillator or an organic scintillator. The inorganic scintillator may contain NaI(Tl), ZnS(Ag). CsI(Tl), LiI(Tl), or the like. The light detection unit 120 may have an area greater than that of the object 200. The light detection unit 120 may generate light by detecting the beam generated from the light source unit 110 and inject the generated light to the optical unit 130.

The optical unit 130 may receive the light generated from the light detection unit 120. The optical unit 130 may form an image by using the light. The optical unit 130 may optically use the light to form the image. The optical unit 130 may magnify or reduce the image.

The optical unit 130 may include a microscope. The optical unit 130 may generate a real image that is primarily magnified through the light obtained from the light detection unit 120 by using an objective lens having a short focal distance and re-magnify the real image by using an ocular lens.

The optical unit 130 may generate the real image magnified by the objective lens when the light generated from the light detection unit 120 is injected outside a focal spot F1 of the objective lens. The primarily magnified real image plays a role of the object when viewed from the ocular lens. Since the primarily magnified image is formed within a visibility distance and thus is not clearly seen, a clear image may be seen by sending the image backward using a convex lens. As the image formed by the light generated from the light detection unit 120 is pulled within the visibility distance, and the magnified image is again formed behind the ocular lens that is the convex lens, a magnified virtual image may be clearly seen to us.

The optical unit 130 may magnify the object to be exactly observed. The optical unit 130 may magnify the image and maintain a resolution of the image. The optical unit 130 may use a visible ray having a wavelength range of about 400 nm to 700 nm. When blue light having a short wavelength range of 400 nm among light in the above range is used, a resolution may be about 200 nm, and a maximum magnification may be about 1000 times.

The defect detector 140 may determine whether a defect is generated in the object 200 by using the image generated from the optical unit 130. The defect detector 140 may display a position at which the defect is generated in the object 200. The defect detector 140 may recognize and display the number of defects generated in the object 200. The defect detector 140 may display a defect rate according to the position and number of defects of the object 200.

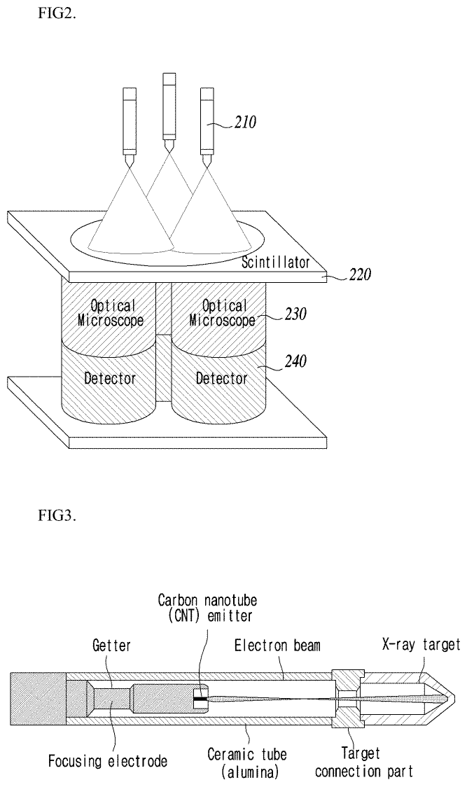

FIG. 2 is a view illustrating a nondestructive inspection apparatus for micro defect inspection according to an embodiment of the present invention.

Referring to FIG. 2, a light source unit 210, an optical unit 230, and a defect detector 240 may be provided in plurality in comparison with the nondestructive inspection apparatus for micro defect inspection in FIG. 1.

The plurality of light source units 210 may project beams to the object 200 individually or simultaneously. The plurality of light source units 210 may irradiate a plurality of different areas of the object 200 with the beams, respectively. The areas irradiated by the plurality of light source units 210 with the beams may overlap each other. Alternatively, the areas irradiated by the plurality of light source units 210 with the beams may not overlap each other. As the plurality of light source units 210 simultaneously move in a group, the area of the object 200, which is irradiated with the beam, may also move. Alternatively, as the plurality of light source units 210 individually move, the area of the object 200, which is irradiated with the beam, may also move. When the beam emitted from the light source unit 210 is projected to the object 200 and arrived at the optical detecting unit 220, the light detection unit 220 may detect the beam and generate light only in an area at which the beam is arrived.

The plurality of optical units 230 may form an image by detecting light generated when the beams emitted from the plurality of light source units 210 are arrived at the light detection unit 220. The plurality of optical units 230 may be disposed at positions corresponding to areas at which a plurality of beams emitted from the plurality of light source units 210 are arrived.

According to an embodiment of the present invention, the optical unit 230 may have an area including all of the plurality of areas which are irradiated with the plurality of beams. When the beams emitted from the plurality of light source units 210 are arrived at the light detection unit 220 to generate light, the optical unit 230 may accommodate all of light generated from the plurality of areas to generate the image.

The defect detector 240 may detect whether a defect is generated in the object 200 by using the image generated from the optical unit 230. The defect detector 240 may be provided in plurality. The plurality of defect detectors 240 may be disposed at positions corresponding to the plurality of optical units 230 with the same number as each other. The defect detectors 240 may recognize the position, number, and the like of each of defects in a plurality of images generated by the plurality of beams of the plurality of light source units 210, and synthetically provide the position and number of defects of the plurality of images.

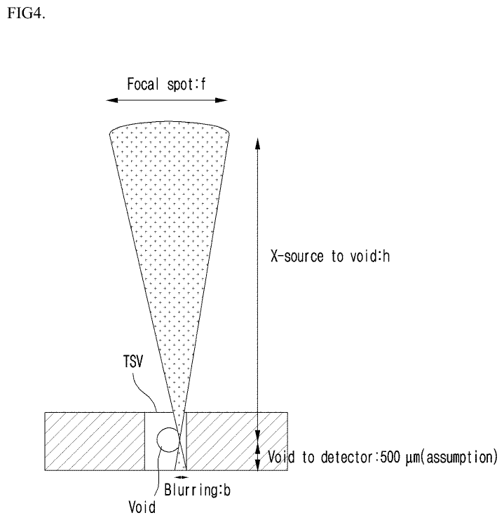

FIG. 3 is a view illustrating an ultra-miniature X-ray tube according to an embodiment of the present invention.

Referring to FIG. 3, the ultra-miniature X-ray tube according to an embodiment of the present invention may be a micro-focus X-ray tube or a miniature X-ray tube, and include a carbon nanotube. The micro-focus X-ray tube or miniature X-ray tube may generate an X-ray having a focal spot size of 5 mm or less and acquire an internal image of a semiconductor, which is magnified 200 times or more, by using the X-ray. The micro-focus X-ray tube or miniature X-ray tube may have a vacuum sealing type having an outer diameter of 10 mm and a tube voltage of 50 kV on the basis of a carbon nanotube. The micro-focus X-ray tube or miniature X-ray tube may have an outer diameter of 7 mm, and have an outer diameter of 17 mm when a high voltage insulation part is contained. Here, a driving voltage may be 50 kV. The micro-focus X-ray tube or miniature X-ray tube may have a diameter of 7 mm, and have a diameter of 11 mm when the high voltage insulation part is contained. The ultra-miniature X-ray tube may have a tube voltage of 50 kV to 80 kV and a current of 300 μA τo 5000 μA.

A miniature X-ray tube according to another embodiment of the present invention may include a carbon nanotube, and the tube may have a diameter of 10 mm or less and a length of 60 mm or less. The miniature X-ray tube may have a vacuum sealing type, and a level of vacuum is 10⁻⁶ torr. A tube voltage may be equal to or greater than 50 kV, and a current may be equal to or greater than 400 μA.

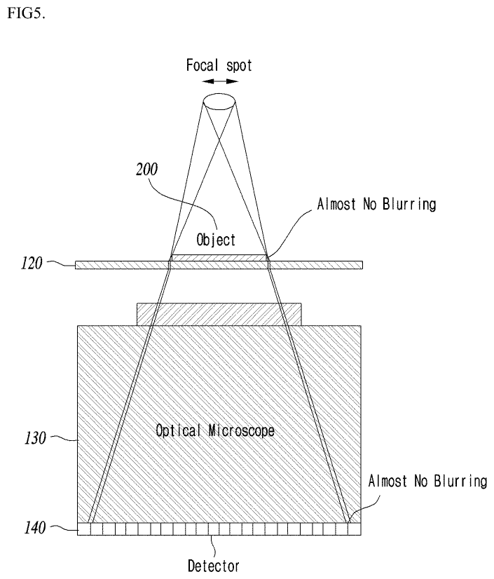

FIG. 4 is a view illustrating blurring generated in a nondestructive inspection according to an embodiment of the present invention.

Referring to FIG. 4, a calculation is performed by assuming that a position of a through silicon via (TSV) defect is spaced 500 μm from the light detection unit. When a portion of the light source unit, from which a beam is emitted, has a diameter of f, a linear distance from the light source unit to a defect contained in the object is h, and a diameter of blurring generated in the light detection unit is b, a relationship of f:b=h:500 μm is established.

Thus, the generated blurring may be expressed as “b=500f/h μm”.

When it is assumed that the blurring should have a size that is one-third of a size of a sample to be observed (the smaller the better), in case of a defect having a size of 3 μm, b should be less than 1 μm. That is, a ratio of f/h should be less than 1/500. When h is 10 cm, and a focal spot f is less than 200 μm, an image of blurring having a size of 1 μm or less may be formed on the light detection unit.

That is, the ratio of f/h is a key factor. When the focal spot is great, h should increase. However, in this case, a current is necessary to increase for acquiring the image. According to an embodiment of the present invention, a size of each of particles of the light detection unit may be equal to or less than that of blurring.

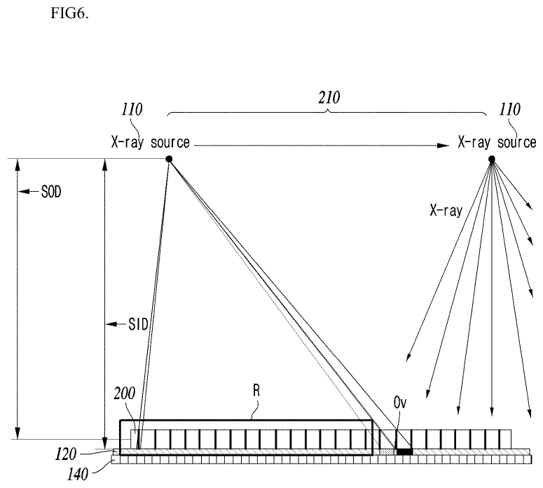

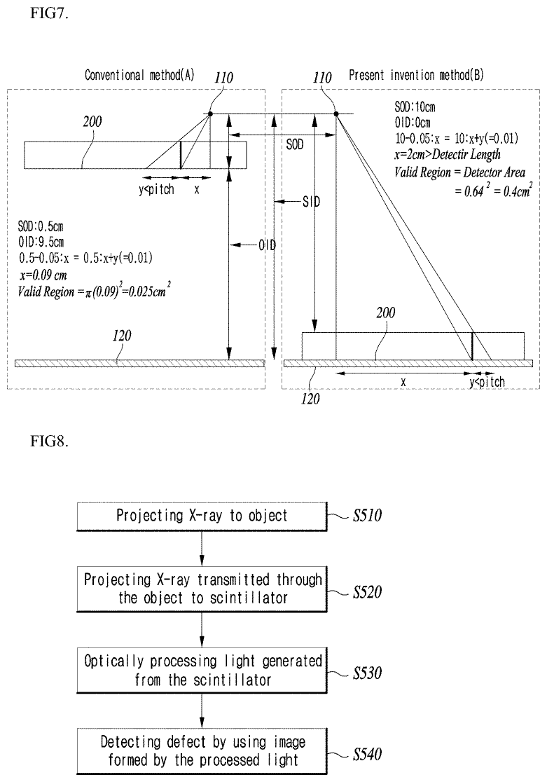

FIGS. 5 to 7 are views for explaining an effect of a nondestructive inspection according to an embodiment of the present invention. More particularly, FIG. 5 is a view for explaining an effect of magnifying an image of a nondestructive inspection and acquiring a high resolution image according to an embodiment of the present invention, and FIGS. 6 and 7 are views for explaining an effect of inspecting a wide area of an object to be inspected according to an embodiment of the present invention.

Referring to FIG. 5, a nondestructive inspection apparatus according to an embodiment of the present invention may minimize blurring of an image formed on the light detection unit (scintillator) 120 because the light detection unit 120 contacts the object 200. Thus, when a miniature X-ray tube is used as the light source unit 110, a limitation of generating great blurring in comparison with the object when an image is magnified even in case of a relatively great focal spot may be resolved.

Referring to FIGS. 6 and 7, a nondestructive inspection apparatus according to an embodiment of the present invention may inspect a wide area of an object.

Referring to FIG. 6, since a distance from the light source unit 110 to the object 200, i.e., a source to object distance SOD, occupies most of a total distance, i.e., a source to image distance SID, a distance to an overlapped portion (Ov) of an image, i.e., a distance of an effective area R of the X-ray tube, is significantly extended in comparison with a conventional inspection method. Thus, when an object is inspected according to an embodiment of the present invention, even in case of a current, an image on a wider area may be acquired in comparison with a conventional method. Hereinafter, in case of the conventional inspection method, the micro-focus X-ray tube is used, and in case of the present invention, the miniature X-ray tube is used as the light source unit.

Furthermore, since the nondestructive inspection apparatus according to an embodiment of the present invention includes the plurality of light source units 210, another X-ray tube disposed at another position may simultaneously measure an area, which is not covered by one X-ray tube, and thus an area of the object, which is detectable by using the X-ray tube, may be expanded.

Hereinafter, FIG. 6 will be described in more detail with reference to FIG. 7.

A left portion (A) represents a conventional method, and a right portion (B) represents an inspection method according to an embodiment of the present invention.

In the above two methods, a height (h) of the object is 500 μm, a total distance SID from the light source unit 110 to the light detection unit 120 is 10 cm, a diameter of a beam is 5 μm, a pitch is 100 μm, and the same current is applied.

In the conventional method (A), the distance SOD from the light source unit 110 to the object 200 is 0.5 cm, and the distance OID from the object 200 to the light detection unit 120 is 9.5 cm. Thus, according to an equation of SOD-h:x=SOD:x+y(pitch=0.01), x that satisfies an equation of is 0.09 cm. Thus, an effective area is.

In the method (B) according to an embodiment of the present invention, since the distance SOD from the light source unit 110 to the object 200 is the same as the total distance SID, the distance SOD is assumed as 10 cm. Also, since the object 200 contacts the light detection unit 120, the distance OID from the object to the light detection unit 120 is 0 cm. Thus, according to the equation of SOD-h:x=SOD:x+y(pitch=0.01), x that satisfies an equation of is 2 cm. Since a value of 2 cm is greater than a length (0.64 cm) of the light detection unit, the effective area may be an area of the light detection unit. Thus, the effective area is.

As a result, the method (B) according to an embodiment of the present invention may effectively detect an area that is 20 times wider than that of the conventional method (A). Since the above-described result is proportional to the square of the ratio between OID and SOD, in the conventional method, as the micro-focus X-ray tube gradually magnifies, the difference increases.

Furthermore, since the method (B) according to an embodiment of the present invention uses the miniature X-ray tube, a manufacturing cost is cheaper 100 times or more than that when the micro-focus X-ray tube is used, and although a plurality of miniature X-ray tubes are used, the manufacturing cost may be much inexpensive. Also, an inspectable area may be expanded in proportion to the number of the miniature X-ray tubes.

FIG. 8 is a flowchart representing a nondestructive inspection method for micro defect inspection according to an embodiment of the present invention.

Referring to FIG. 8, the nondestructive inspection method for micro defect inspection according to an embodiment of the present invention may include a process S510 of projecting a beam to an object.

In the process S510, the light source unit 110 may generate a beam. The beam generated from the light source unit 110 may be shot or emitted toward the object 200. The beam generated from the light source unit 110 may be emitted only in a specific direction or to a specific area. The beam generated from the light source unit 110 may include an X-ray, a laser, or a gamma ray. Preferably, the beam may be the X-ray. The light source unit 110 may include a micro-focus X-ray tube. The light source unit 110 may have a focal spot size of 3 mm to 8 mm, preferably 5 mm or less. According to another embodiment of the present invention, the light source unit 110 may have a focal spot size of 0.1 mm to 5 mm, preferable 2 mm or less. The light source unit 110 may generate the X-ray by using a carbon nanotube. The light source unit 110 may irradiate a whole or a portion of the object 200 with the beam. The light source unit 110 may move or change an area to which the beam is projected. The light source unit 110 may move or change the area to which the beam is projected so that the beam is projected to the entire object 200. The light source unit 110 may adjust a distance to the object. The light source unit 110 may adjust a size of the area of the object, which is irradiated with the beam. The light source unit 110 may allow the beam to be emitted to the object 200 and then arrived at the light detection unit 120. Although the light source unit 110 may emit the beam in a shape such as a circle, a triangle, a rectangle, and a hexagon, the embodiment of the present invention is not limited thereto. For example, the light source unit 110 may emit the beam in various shapes.

In the process S510, the plurality of light source units 210 may project beams to the objects 200 individually or simultaneously. The plurality of light source units 210 may emit the beams to a plurality of different areas of the objects 200, respectively. Areas to which the plurality of light source units 210 emit the beams may overlap each other. Alternatively, the areas to which the plurality of light source units 210 emit the beams may not overlap each other. While the plurality of light source units 210 move in a group, the areas of the objects 200, which are irradiated with the beam, may move. Alternatively, while the plurality of light source units 210 moves individually, the areas of the objects 200, which are irradiated with the beam, may move. The beams emitted form the light source units 210 are projected to the objects 200 and arrived at the light detection unit 220, the light detection unit 220 may detect the beams only in the area at which the beams are arrived and generate light.

The nondestructive inspection method for micro defect inspection according to an embodiment of the present invention may include a process S520 of detecting the beam, which is transmitted through the object and arrived, to generate light.

In the process S520, the light detection unit 120 may detect the beam when the beam emitted from the light source unit 110 is arrived. The light detection unit 120 may diffuse, form, or generate light when the beam is detected. The light detection unit 120 may contact at least one surface of the object 200. The light detection unit 120 may receive the beam emitted from the light source unit 110 through the surface contacting the object 200. The light detection unit 120 may include a scintillator. The scintillator may contain a fluorescent material that emits light when collides with a radioactive ray. The scintillator may include an inorganic scintillator or an organic scintillator. The inorganic scintillator may contain NaI(Tl), ZnS(Ag), CsI(Tl), LiI(Tl), or the like. The light detection unit 120 may have an area greater than that of the object 200. The light detection unit 120 may generate light by detecting the beam generated from the light source unit 110 and inject the generated beam to the optical unit 130.

The nondestructive inspection method for micro defect inspection according to an embodiment of the present invention may include a process S530 of forming an image by using the light.

In the process S530, the optical unit 130 may receive the light generated by the light detection unit 120. The optical unit 130 may form the image by using the light. The optical unit 130 may form the image by optically using the light. The optical unit 130 may magnify or reduce the image.

In the process S530, the optical unit 130 may include a microscope. The optical unit 130 may generate a real image that is primarily magnified through light obtained from the light detection unit 120 by using an objective lens having a short focal distance and re-magnify the real image by using an ocular lens.

In the process S530, the optical unit 130 may generate the real image magnified by the objective lens when the light generated from the light detection unit 120 is injected outside the focal spot F1 of the objective lens. The primarily magnified real image plays a role of the object when viewed from the ocular lens. Since the primarily magnified image is formed within a visibility distance and thus is not clearly seen, a clear image may be seen by sending the image backward using a convex lens. As the image formed by the light generated from the light detection unit 120 is pulled within the visibility distance, and the magnified image is again formed behind the ocular lens that is the convex lens, the magnified virtual image may be clearly seen to us.

In the process S530, the optical unit 130 may magnify the object to be exactly observed. The optical unit 130 may magnify the image and maintain a resolution of the image. The optical unit 130 may use a visible ray having a wavelength range of about 400 nm to 700 nm. When blue light having a short wavelength range of 400 nm among light in the above range is used, a resolution may be about 200 nm, and a maximum magnification may be about 1000 times.

In the process S530, the plurality of optical units 230 may form an image by detecting light generated when the beams emitted from the plurality of light source units 210 are arrived at the light detection unit 220. The plurality of optical units 230 may be disposed at positions corresponding to areas at which a plurality of beams emitted from the plurality of light source units 210 are arrived.

In the process S530, the optical unit 230 may have an area including all of the plurality of areas which are irradiated with the plurality of beams. When the beams emitted from the plurality of light source units 210 are arrived at the light detection unit 220 to generate light, the optical unit 230 may accommodate all of light generated from the plurality of areas to generate the image.

The nondestructive inspection method for micro defect inspection according to an embodiment of the present invention may include a process S540 of determining whether a defect is generated by using the image.

In the process S540, the defect detector 140 may determine whether a defect is generated in the object 200 by using the image generated from the optical unit 130. The defect detector 140 may display a position at which the defect is generated in the object 200. The defect detector 140 may recognize and display the number of defects generated in the object 200. The defect detector 140 may display a defect rate according to the position and number of defects of the object 200

In the process S540, the defect detector 240 may detect whether a defect is generated in the object 200 by using the image generated from the optical unit 230. The defect detector 240 may be provided in plurality. The plurality of defect detectors 240 may be disposed at positions corresponding to the plurality of optical units 230 with the same number as each other. The defect detectors 240 may recognize the position, number, and the like of each of defects in a plurality of images generated by the plurality of beams of the plurality of light source units 210, and synthetically provide the position and number of defects of the plurality of images.

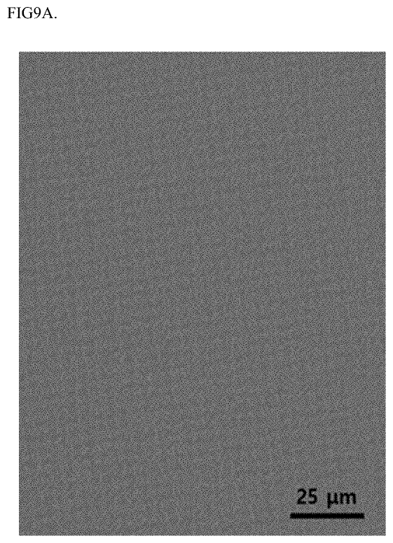

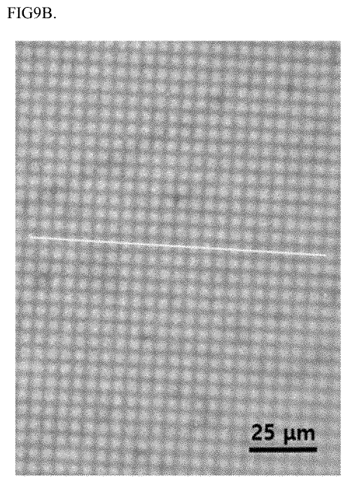

FIGS. 9A and 9B are views showing results of a comparative experiment on the effect of the micro defect inspection between the conventional method and an embodiment of the present invention. FIG. 9A is a view showing an X-ray image obtained by the micro defect inspection according to the conventional method, and FIG. 9B is a view showing an X-ray image obtained by the micro defect inspection according to an embodiment of the present invention. The X-ray image is acquired by using a 2000 mesh TEM grid with a bar having a thickness of 5 μm. The X-ray image acquired according to an embodiment of the present invention is more clear than that acquired by using an apparatus including a light source having a focal spot size of 10 μm.

According to the present invention, the nondestructive inspection capable of magnifying the image of the nondestructive inspection and maintaining the resolution of the image may be performed.

Also, the present invention may provide the technology capable of reducing the inspection time because the present invention may inspect the defect of the object in a wide range in comparison with the conventional nondestructive inspection method.

The effect of the present invention is not limited to the aforesaid, but other effects not described herein will be clearly understood by those skilled in the art from descriptions below.

As described above, preferred embodiments of the present invention are mainly described. It will be understood by those skilled in the art that various changes in form and details may be made therein without departing from the spirit and scope of the invention as defined by the appended claims. Therefore, the preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A nondestructive inspection apparatus for micro defect inspection, comprising:
a light source unit configured to project a beam to an object;
a light detection unit having at least one surface contacting the object to generate light by detecting the beam that is transmitted through the object and arrived;
an optical unit configured to form an image by using the light generated from the light detection unit; and
a defect detector configured to determine whether a defect is generated by using the image.

2. The nondestructive inspection apparatus of claim 1, wherein the light source unit is provided in plurality, and each of the plurality of light source units projects a beam to a different area.

3. The nondestructive inspection apparatus of claim 1, wherein the light source unit generates an X-ray.

4. The nondestructive inspection apparatus of claim 3, wherein the light source unit comprises a micro-focus X-ray tube or a miniature X-ray tube.

5. The nondestructive inspection apparatus of claim 2, wherein the optical unit is provided in plurality, and the plurality of optical units are contained in an area at which a beam projected from each of the plurality of light source units is arrived.

6. The nondestructive inspection apparatus of claim 1, wherein the optical unit magnifies or reduces an image formed by the light generated from the light detection unit.

7. The nondestructive inspection apparatus of claim 5, wherein the defect detector is provided in plurality, and the plurality of defect detectors are disposed at positions corresponding to the plurality of optical units.

8. A nondestructive inspection method for micro defect inspection, comprising:
projecting a beam to an object;
generating light by detecting the beam that is transmitted through the object and arrived;
forming an image by using the generated light; and
determining whether a defect is generated by using the image.

9. The nondestructive inspection method of claim 8, wherein the projecting of the beam projects the beam to a plurality of different areas.

10. The nondestructive inspection method of claim 8, wherein the beam projected in the projecting of the beam is an X-ray.

11. The nondestructive inspection method of claim 10, wherein the projecting of the beam projects the X-ray by using a micro-focus X-ray tube or a miniature X-ray tube.

12. The nondestructive inspection method of claim 9, wherein the forming of the image forms a plurality of images by using light generated from the plurality of areas at which the beam is arrived.

13. The nondestructive inspection method of claim 8, wherein the forming of the image magnifies or reduces the image.
